(19) United States
(12) Patent Application Publication
(10) Pub. No.: US 2015/0349962 A1
(43) Pub. Date: Dec. 3, 2015

(54) Electronic method for applying an electronic signature and e-notation without active internet service

(71) Applicant: WWNotary, LLC, Brady, TX (US)

(72) Inventors: Bob Rice, Brady, TX (US); Jason Streit, Vernon, TX (US)

(73) Assignee: WWNotary, Brady, TX (US)

(21) Appl. No.: 14/711,873

(22) Filed: May 14, 2015

Related U.S. Application Data
(60) Provisional application No. 62/003,737, filed on May 28, 2014.

(51) Int. Cl. H04L 9/32; G06F 21/64

(52) U.S. Cl. CPC H04L 9/3247; G06F 21/64

(57) ABSTRACT

An electronic method and system for applying an electronic signature and e-notarization without active internet service is disclosed. An e-notary can sign and notarize one or more documents without an internet connection.

This application claims the benefit of U.S. Provisional Patent Application Serial No. [] filed [].

### FIELD OF THE INVENTION

The present invention relates generally to the field of notarization of documents and, more particularly, to a method and system for signing and notarizing documents electronically without the need for active access to the Internet.

### BACKGROUND OF THE INVENTION

An e-Notary is a Notary Public who notarizes documents electronically. One of the methods employed by an e-Notary is the use of a digital signature and digital notary seal to notarize a digital document and validate with a digital certificate. Electronic notarization is a process whereby a notary affixes an electronic signature and notary seal using a secure public key to an electronic document (such as an image document or a word processing document. Once affixed to the electronic document, the document is rendered tamper evident so that unauthorized attempts to alter the document will be evident to anyone who relies on the authenticity of the signatures to the document. The e-notary will use cryptograph and public key infrastructure to create, manage, distribute, use, store, and revoke the digital certificate. The Electronic Notary also must keep an electronic register of each act performed.

In most cases, electronic notarization does not mean that the notary can perform the electronic notarization remotely as most states still require that the participants and the notary must all be physically present at the time of signing. There are also significant benefits to having the notarizations done electronically such as cost savings, superior security, authenticity, audit trails, and document integrity, which are things that are not available to paper based notarizations.

Currently e-signatures and e-notarization of electronic documents require active internet service for the transmission of the document and for the e-Notary to carry out the legal functions of the e-Notary. The only way to sign and notarize a document requires that the e-Notary to be connected to the internet. Thus, there remains a need for a method and system that allows the signatories to a document to sign and an e-Notary to notarize one or more documents without active access to the Internet.

### SUMMARY OF THE INVENTION

This invention addresses these and other drawbacks in the art by providing an electronic method and system for applying an electronic signature and e-notarization without active internet service. An e-notary can sign and notarize one or more documents without an internet connection.

### BRIEF DESCRIPTION OF THE DRAWING

So that the manner in which the above recited features, advantages and objects of the present invention are attained and can be understood in detail, more particular description of the invention, briefly summarized above, may be had by reference to embodiments thereof which are illustrated in the appended drawings.

FIG. 1 is a logic flow diagram of a system and method of notarization of a document in accordance with the teachings of the present invention.

### DETAILED DESCRIPTION OF A PREFERRED EMBODIMENT

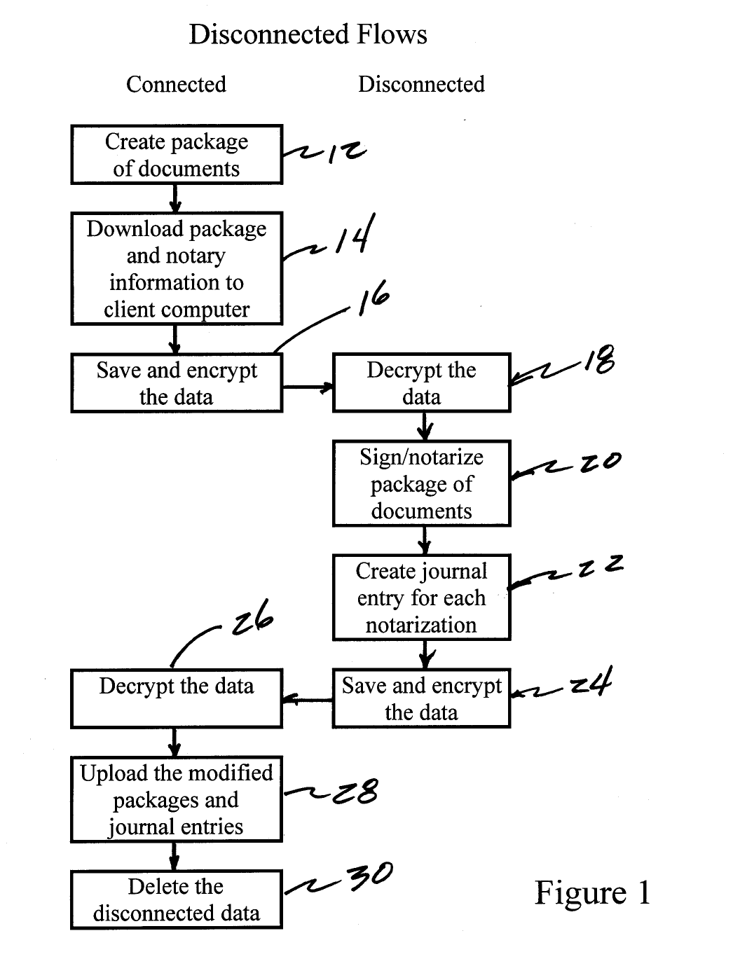

Currently, e-signatures and e-notarization of electronic documents require active internet service. The method and system claimed herein solves this problem. With method shown in FIG. 1, an e-notary can create or design documents through a connected interface and then download and encrypt a document or group of documents to be signed and e-notarized without being connected to the internet

The system shown and described herein differs from what currently exists. The user can download a package of documents and notary information from a server which are encrypted and stored on a local computer. The user can then sign and notarize that document(s) without an internet connection using the application. The package of documents and journal entries are then uploaded the next time the user is connected to the internet.

There are areas in the United States, indeed throughout the world, that users do not have internet access even using their cell phone connection such as rural areas. This invention allows a user to sign and notarize one or more documents using an autonomous computer, with the need for internet connection.

FIG. 1 illustrates the steps in the method 10 of this invention. In step 12, a user, such as an agent or other user, creates a document or a package of documents, preferably while connected to the Internet. In step 14, the user then downloads the document(s) to a client computer, along with notary information. This information (data) is next saved and encrypted in step 16.

At this point, the encrypted data on a portable or laptop computer may be transported to a customer, i.e. the one who is to execute the document(s), who may not access to the Internet. At this point, the data are referred to a “disconnected.” At the customer, the data is decrypted in step 18, so that the document(s) can be executed in step 20, including signing and notarization. As required by law, each notarization is immortalized with a journal entry in step 22. Once the journal entries are complete, the disconnected data are saved and encrypted in step 24. At this point, the disconnected data is available for transport back to the base of the user, agent, Notary Public, or other user, at which point the data returns to being “connected.”

At this point, the connected is decrypted in step 26. The decrypted, connected data, which is now notarized, is then uploaded to its intended destination, including the journal entries in step 28. Finally, in step 30, the disconnected data is deleted, since it is now redundant and for security reasons.

The connected application is used to create/design the package of document and to create the disconnected data to the client. The disconnected application is used to work with the disconnected data including but not limited to signing and notarizing and creating journal entries. The connected application is then used to upload all modified data to be saved and delete the disconnected data from the client.

When the user is working disconnected it checks if disconnected data exists; if not, then it will not allow the user to work disconnected. When a user connects to the Internet, it checks if disconnected data exists and if it does it uploads modified data.

In using the method, as an example, a user creates a package of mortgage documents with all coordinates set. The user then selects the package to be downloaded and the data is saved to the local computer and encrypted. The user then disconnects from the internet and goes to the signing location. The user then pulls up the disconnected package of documents at which point the document(s) and signed and notarized. At the same time, notary journal entries are made. All the disconnected data are then saved, including the changes to the disconnected data. The user then reconnects to the internet and the invention uploads the modified data to be saved.

The principles, preferred embodiment, and mode of operation of the present invention have been described in the foregoing specification. This invention is not to be construed as limited to the particular forms disclosed, since these are regarded as illustrative rather than restrictive. Moreover, variations and changes may be made by those skilled in the art without departing from the spirit of the invention.

I claim:

1. A method of notarizing one or more documents without Internet access, comprising the steps of:
a. creating a package of documents;
b. downloading the package of documents and notary information to client computer;
c. encrypting and saving the data;
d. transporting the data on the client computer to a location without connection to the Internet;
e. decrypting the data;
f. signing and notarizing the package of documents;
g. creating a journal entry for each notarization;
h. encrypting and saving the notarized data to define disconnected data;
i. transporting the notarized data to a location with Internet access;
j. decrypting the data; and
k. uploading the modified packages and journal entries via the Internet.

2. The method of claim 1, further comprising the step of deleting the disconnected data after uploading the modified packages.

3. A system for notarizing one or more documents without Internet access, comprising the steps of:
a. means for creating a package of documents;
b. means for downloading the package of documents and notary information to client computer;
c. means for encrypting and saving the data;
d. means for transporting the data on the client computer to a location without connection to the Internet;
e. means for decrypting the data;
f. means for signing and notarizing the package of documents;
g. means for creating a journal entry for each notarization;
h. means for encrypting and saving the notarized data to define disconnected data;
i. means for transporting the notarized data to a location with Internet access;
j. means for decrypting the data; and
k. means for uploading the modified packages and journal entries via the Internet.
